(19) United States
(12) Patent Application Publication
(10) Pub. No.: US 2025/0292953 A1
(43) Pub. Date: Sep. 18, 2025

(54) COIL COMPONENT

(71) Applicant: TDK CORPORATION, Tokyo (JP)

(72) Inventors: Yusuke NAGAI, Tokyo (JP); Hidenobu Umeda, Tokyo (JP); Kouichi Kakuda, Tokyo (JP); Shinichi Sato, Tokyo (JP); Kosuke Ito, Tokyo (JP); Youhei IIda, Tokyo (JP); Mitsuharu Koike, Tokyo (JP); Keito Yasuda, Tokyo (JP); Takuya Miyashita, Tokyo (JP)

(73) Assignee: TDK CORPORATION, Tokyo (JP)

(21) Appl. No.: 19/076,789

(22) Filed: Mar. 11, 2025

(30) Foreign Application Priority Data
Mar. 14, 2024 (JP) 2024-039816

(51) Int. Cl. H01F 27/29; H01F 27/255; H01F 27/28

(52) U.S. Cl. CPC H01F 27/292; H01F 27/255; H01F 27/2804; H01F 2027/2809

(57) ABSTRACT

In a coil component, the element body comprises four portions. The first portion includes a main surface and a region between a pair of terminal electrodes in a second direction. The second portion is located between the first portion and the coil conductor layer closest to the main surface in a first direction. The third portion is situated between the coil conductor layers closest to the main surface in the first direction, excluding the region between the coil conductor layers facing each other in the first direction. The fourth portion includes the main surface and is located between the main surface and the third portion in the first direction. The average particle diameter of metal magnetic particles in the first portion is smaller than that in any of the second, third, and fourth portions.

### TECHNICAL FIELD

The present disclosure relates to a coil component.

### BACKGROUND

A coil component includes an element body, a coil disposed inside the element body, and a pair of terminal electrodes disposed on a mounting surface of the element body and connected to the coil (see, for example, Japanese Unexamined Patent Publication No. 2020-141079).

### SUMMARY

An object of one aspect of the present disclosure is to provide a coil component capable of securing coil characteristics while suppressing a short circuit in a pair of terminal electrodes.
(1) A coil component according to one aspect of the present disclosure includes: an element body formed to include a plurality of metal magnetic particles of a soft magnetic material and having a mounting surface and a main surface opposed to each other in a first direction; a pair of terminal electrodes located to be exposed to the mounting surface and disposed to face each other in a second direction; and a coil disposed in the element body and configured by a plurality of coil conductors. The element body includes a first portion including the mounting surface and including a region between the pair of terminal electrodes in the second direction, a second portion between the first portion and the coil conductor located closest to the mounting surface in the first direction, a third portion between the coil conductor located closest to the main surface and the coil conductor located closest to the mounting surface in the first direction, the third portion not including a region between the coil conductors facing each other in the first direction, and a fourth portion including the main surface and located between the main surface and the third portion in the first direction. An average particle diameter of the metal magnetic particles in the first portion is smaller than an average particle diameter of the metal magnetic particles in any of the second portion, the third portion, and the fourth portion.

In the coil component according to one aspect of the present disclosure,
an average particle diameter of the metal magnetic particles in the first portion is smaller than an average particle diameter of the metal magnetic particles in any one of the second portion, the third portion, and the fourth portion. As a result, in the coil component, the number of metal magnetic particles existing between the pair of terminal electrodes can be increased as compared with other portions. Therefore, in the coil component, the number of interfaces of the metal magnetic particles existing between the pair of terminal electrodes can be sufficiently secured, and the withstand voltage between the pair of terminal electrodes can be improved. Therefore, in the coil component, a short circuit in the pair of terminal electrodes can be suppressed.

In the coil component, the average particle diameter of the metal magnetic particles in any of the second portion, the third portion, and the fourth portion is larger than the average particle diameter of the metal magnetic particles in the first portion. As a result, in the coil component, magnetic permeability can be secured in the second portion, the third portion, and the fourth portion. Therefore, in the coil component, since inductance can be secured, coil characteristics can be maintained.
(2) In the coil component of the above (1), at least a part of each of the pair of terminal electrodes may be disposed inside the element body.
(3) In the coil component of the above (1) or (2), a first dimension of the first portion in the first direction may be larger than a second dimension of the terminal electrode in the first direction. In this configuration, the number of interfaces of the metal magnetic particles existing between the pair of terminal electrodes arranged inside the element body can be sufficiently secured. Therefore, in the coil component, in the configuration in which the pair of terminal electrodes is disposed inside the element body, the withstand voltage between the pair of terminal electrodes can be improved.
(4) In the coil component of the above (3), the first dimension may be twice or less the second dimension. When the first dimension of the first portion is larger than twice the second dimension, the magnetic permeability of the element body may decrease. In the coil component, by setting the first dimension of the first portion to twice or less of the second dimension, it is possible to secure coil characteristics while suppressing a short circuit in the pair of terminal electrodes.
(5) In the coil component according to any one of the above (1) to (4), the first portion may be provided between each of the pair of terminal electrodes and the coil in the first direction. In this configuration, it is possible to suppress generation of stray capacitance between each of the pair of terminal electrodes and the coil.
(6) In the coil component according to any one of the above (1) to (5), the first portion may include a region having a dimension equal to or larger than a dimension of the terminal electrode in a third direction orthogonal to the second direction as viewed from the first direction. In this configuration, the withstand voltage between the pair of terminal electrodes can be further improved. Therefore, in the coil component, a short circuit in the pair of terminal electrodes can be further suppressed.
(7) In the coil component according to any one of the above (1) to (6), the first portion may include the entire region between the pair of terminal electrodes in the second direction as viewed from the first direction. In this configuration, the withstand voltage between the pair of terminal electrodes can be further improved. Therefore, in the coil component, a short circuit in the pair of terminal electrodes can be further suppressed.
(8) In the coil component according to any one of the above (1) to (7), the first portion may include a region around the terminal electrode. In this configuration, the withstand voltage between the pair of terminal electrodes can be further improved. Therefore, in the coil component, a short circuit in the pair of terminal electrodes can be further suppressed.
(9) In the coil component according to any one of the above (1) to (8), in the first portion, a part of the metal magnetic particles located around the terminal electrode may be embedded in the terminal electrode. In this configuration, adhesion between the element body and the terminal electrode can be secured.
(10) In the coil component of the above (9), in the first portion, the metal magnetic particles may include normal particles having an ellipsoid shape and flat particles having an ellipsoid shape flatter in the thickness direction than the normal particles, and a part of the flat particles may be embedded in the terminal electrode such that the longitudinal direction of the flat particles intersects an outer surface of the terminal electrode. In this configuration, adhesion between the element body and the terminal electrode can be secured.

According to one aspect of the present disclosure, coil characteristics can be secured while a short circuit in a pair of terminal electrodes is suppressed.

### BRIEF DESCRIPTION OF THE DRAWINGS

FIG. 1 is a perspective view of a coil component according to an embodiment;

FIG. 2 is a transparent perspective view of the coil component illustrated in FIG. 1;

FIG. 3 is an exploded perspective view of the coil component;

FIG. 4 is a view illustrating a cross-sectional configuration taken along the line IV-IV in FIG. 1;

FIG. 5 is a view of the coil component as viewed from a main surface side;

FIG. 6A is a view illustrating metal magnetic particles in a first portion, and FIG. 6B is a view illustrating metal magnetic particles in a second portion, a third portion, and a fourth portion.

FIGS. 7A, 7B, 7C, and 7D are views of a coil component according to another embodiment as viewed from a main surface side; and

FIGS. 8A, 8B, 8C, and 8D are views of a coil component according to another embodiment as viewed from a mounting surface side.

### DETAILED DESCRIPTION

In the following, preferred embodiments of the present disclosure will be described in detail with reference to the accompanying drawings. Note that the same or corresponding elements in the description of the drawings are denoted by the same reference signs, and redundant description thereof is omitted.

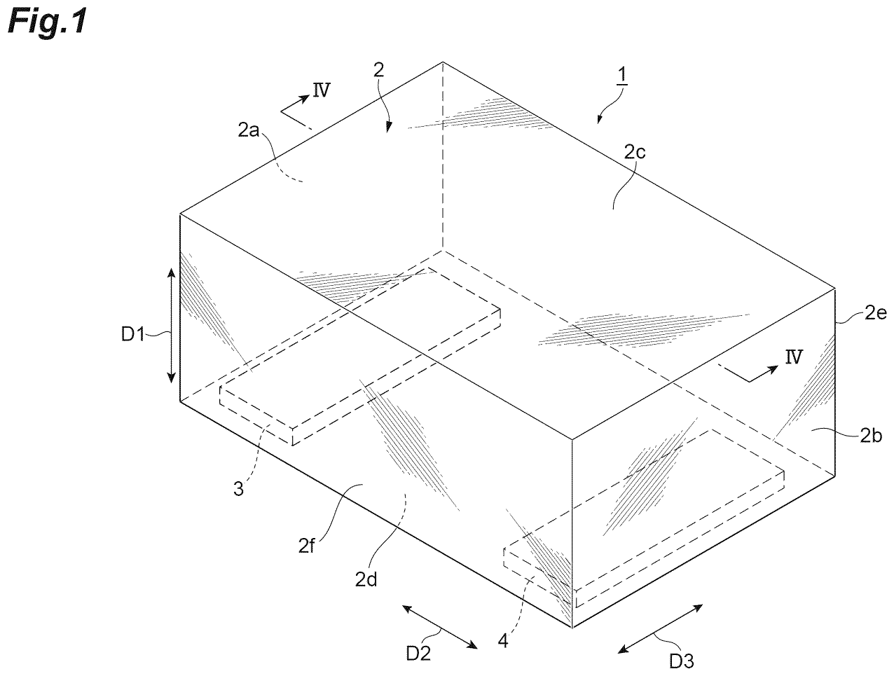

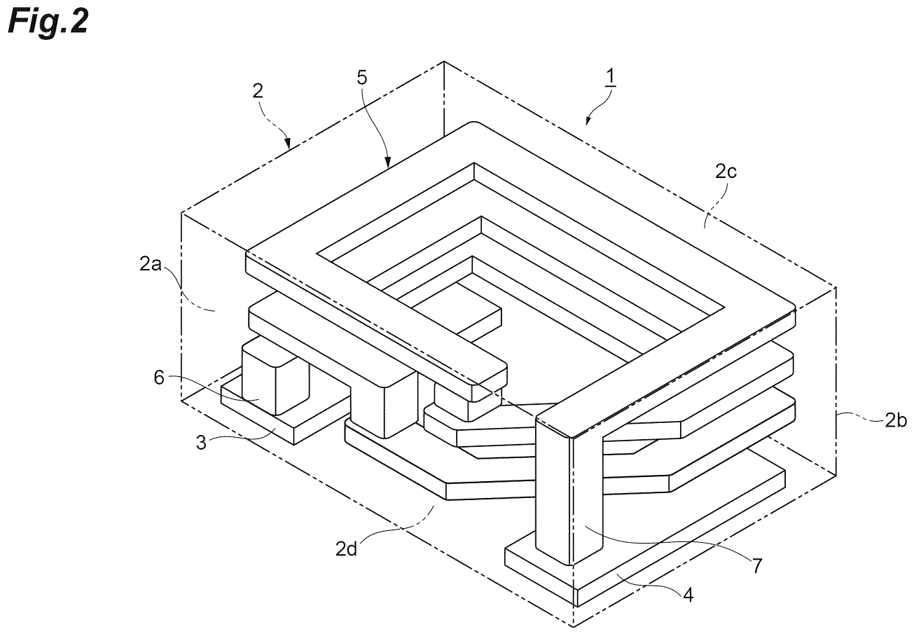

A coil component will be described with reference to FIGS. 1 and 2. FIG. 1 is a perspective view of a coil component according to an embodiment. FIG. 2 is a transparent perspective view of the coil component illustrated in FIG. 1. As illustrated in FIGS. 1 and 2, a coil component 1 includes an element body 2, terminal electrodes 3 and 4, a coil 5, and first and second connection conductors 6 and 7. In FIG. 2, the element body 2 is indicated by a broken line.

The element body 2 has a rectangular parallelepiped shape. The rectangular parallelepiped shape includes a rectangular parallelepiped shape in which corner parts and ridge line parts are chamfered, and a rectangular parallelepiped shape in which corner parts and ridge line parts are rounded. The element body 2 has, as outer surfaces, a pair of end surfaces 2a and 2b, a pair of main surfaces 2c and 2d, and a pair of side surfaces 2e and 2f. The end surfaces 2a and 2b are opposed to each other. The main surfaces 2c and 2d are opposed to each other. The side surfaces 2e and 2f are opposed to each other. Hereinafter, an opposing direction of the main surfaces 2c and 2d is referred to as a first direction D1, an opposing direction of the end surfaces 2a and 2b is referred to as a second direction D2, and an opposing direction of the side surfaces 2e and 2f is referred to as a third direction D3. The first direction D1, the second direction D2, and the third direction D3 are substantially orthogonal to each other.

The end surfaces 2a and 2b extend in the first direction D1 so as to connect the main surfaces 2c and 2d. The end surfaces 2a and 2b also extend in the third direction D3 so as to connect the side surfaces 2e and 2f. The main surfaces 2c and 2d extend in the second direction D2 so as to connect the end surfaces 2a and 2b. The main surfaces 2c and 2d also extend in the third direction D3 so as to connect the side surfaces 2e and 2f. The side surfaces 2e and 2f extend in the first direction D1 so as to connect the main surfaces 2c and 2d. The side surfaces 2e and 2f also extend in the second direction D2 so as to connect the end surfaces 2a and 2b.

The main surface 2d is a mounting surface, and is, for example, a surface facing another electronic device (for example, a circuit substrate or a laminated electronic component) (not illustrated) when the coil component 1 is mounted on the another electronic device. The end surfaces 2a and 2b are surfaces continuous from the mounting surface (i.e., the main surface 2d).

The length of the element body 2 in the second direction D2 is longer than the length of the element body 2 in the first direction D1 and the length of the element body 2 in the third direction D3. The length of the element body 2 in the third direction D3 is longer than the length of the element body 2 in the first direction D1. That is, in the present embodiment, the end surfaces 2a and 2b, the main surfaces 2c and 2d, and the side surfaces 2e and 2f have a rectangular shape. The length of the element body 2 in the first direction D1 may be equal to the length of the element body 2 in the third direction D3, or may be shorter than the length thereof.

It should be noted that “equal” in the present embodiment may not only mean equal but also mean equal to a value including a slight difference, a manufacturing error, or the like in a preset range. For example, when a plurality of values are included within a range of ±5% of an average value of the plurality of values, the plurality of values are defined to be equal.

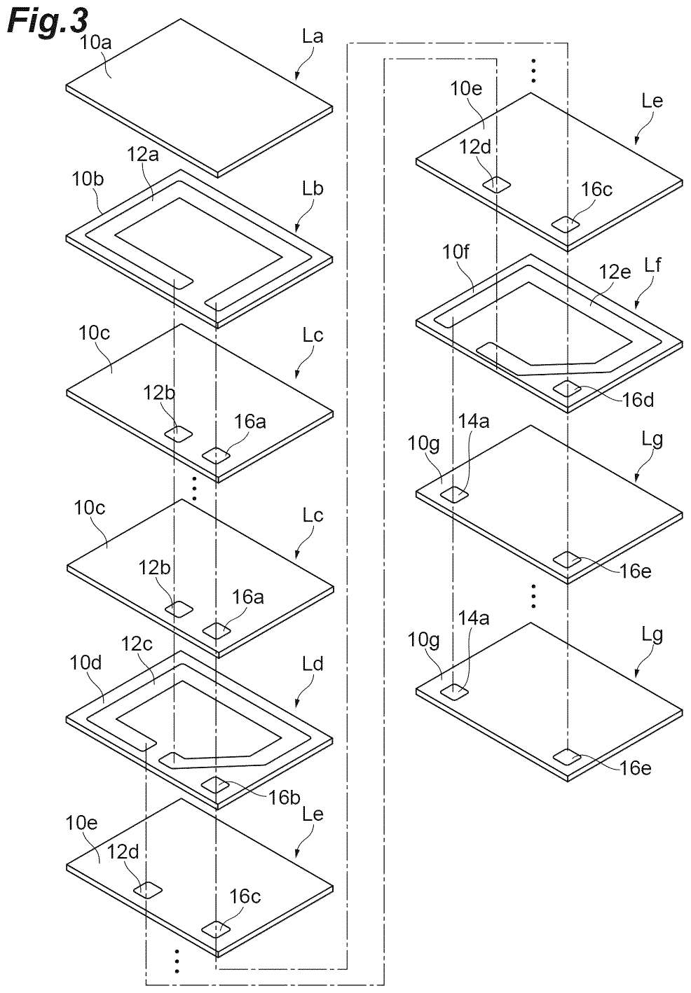

The element body 2 is formed by laminating a plurality of element body layers (insulator layers) 10a to 10g (see FIG. 3) in the first direction D1. That is, the lamination direction of the element body 2 is the first direction D1. A specific laminated configuration will be described below. In the actual element body 2, the plurality of element body layers 10a to 10g are integrated to such an extent that boundaries between the element body layers cannot be visually recognized.

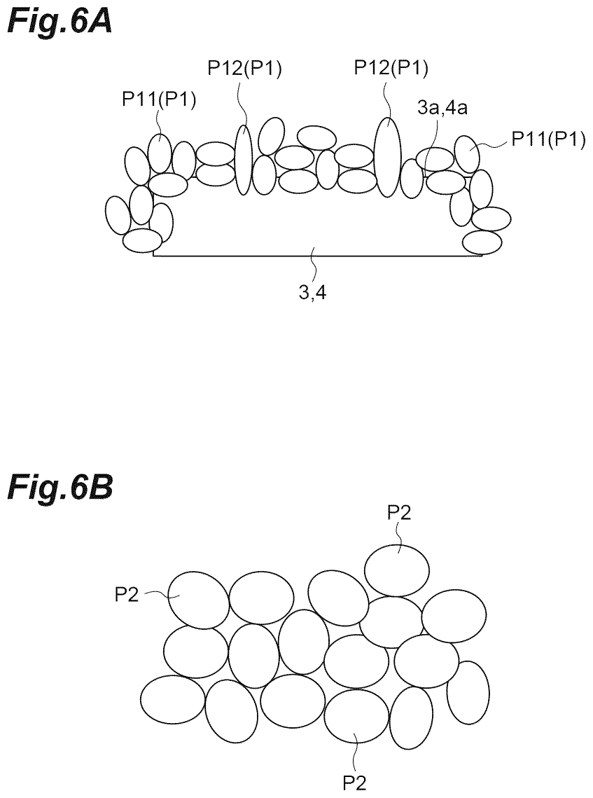

The element body layers 10a to 10g include a plurality of metal magnetic particles P1 and P2 (see FIGS. 6A and 6B). The metal magnetic particles P1 and P2 are made of a soft magnetic alloy (soft magnetic material). The soft magnetic alloy is, for example, a Fe—Si-based alloy. When the soft magnetic alloy is a Fe—Si-based alloy, the soft magnetic alloy may contain P. The soft magnetic alloy may be, for example, a Fe—Ni—Si-M-based alloy. “M” contains one or more elements selected from Co, Cr, Mn, P, Ti, Zr, Hf, Nb, Ta, Mo, Mg, Ca, Sr, Ba, Zn, B, Al, and rare earth elements.

In the element body 2, the metal magnetic particles are bonded to each other. The bonding between the metal magnetic particles is realized by, for example, bonding between oxide films (not illustrated) formed on the surfaces of the metal magnetic particles. The thickness of the oxide film is, for example, 5 nm or more and 60 nm or less. The oxide film may include one or a plurality of layers.

Each of the terminal electrode 3 and the terminal electrode 4 is provided in the element body 2. Each of the terminal electrode 3 and the terminal electrode 4 is disposed on the main surface 2d of the element body 2. The terminal electrode 3 and the terminal electrode 4 are provided in the element body 2 so as to be separated from each other in the second direction D2. Specifically, the terminal electrode 3 is disposed on the end surface 2a side of the element body 2. The terminal electrode 4 is disposed on the end surface 2b side of the element body 2. Each of the terminal electrode 3 and the terminal electrode 4 is embedded in the element body 2. In the present embodiment, the surfaces of the terminal electrode 3 and the terminal electrode 4 are substantially flush with the main surface 2d.

Each of the terminal electrode 3 and the terminal electrode 4 is made of, for example, a conductive material such as Cu, Ni, Sn, or Au. In the present embodiment, each of the terminal electrode 3 and the terminal electrode 4 is a plated electrode (plated conductor) formed by plating (electrolytic plating or electroless plating). Each of the terminal electrode 3 and the terminal electrode 4 may have a single-layer structure or a multi-layer structure.

The coil 5 is disposed in the element body 2. The coil 5 includes a plurality of coil conductor layers (coil conductors) 12a to 12e (see FIG. 3). The plurality of coil conductor layers 12a to 12e are electrically connected to each other and constitute the coil 5 in the element body 2. The coil axis of the coil 5 is provided along the first direction D1. The coil conductor layers 12a to 12e are disposed in such a way as to at least partially overlap each other as viewed from the first direction D1. The plurality of coil conductor layers 12b to 12e are made of a conductive material (for example, Ag or Pd). In the present embodiment, the plurality of coil conductor layers 12a, 12c, and 12e are plated conductors. The coil conductor layers 12a to 12e are disposed apart from the end surfaces 2a and 2b, the main surfaces 2c and 2d, and the side surfaces 2e and 2f.

The first connection conductor 6 is disposed in the element body 2. The first connection conductor 6 connects the terminal electrode 3 and the coil 5. The first connection conductor 6 is a through-hole conductor. The first connection conductor 6 extends in the first direction D1 and is connected to the terminal electrode 3 and one end of the coil 5. The first connection conductor 6 is configured by a plurality of first connection conductor layers 14a (see FIG. 3). In the present embodiment, the first connection conductor 6 has a rectangular cross section (cross section along the second direction D2 and the third direction D3) orthogonal to the extension direction (first direction D1). That is, the first connection conductor 6 has a prismatic shape.

The second connection conductor 7 is disposed in the element body 2. The second connection conductor 7 connects the terminal electrode 4 and the coil 5. The second connection conductor 7 is a through-hole conductor. The second connection conductor 7 extends in the first direction D1 and is connected to the terminal electrode 4 and the other end of the coil 5. The second connection conductor 7 is configured by a plurality of second connection conductor layers 16a, 16b, 16c, 16d, and 16e (see FIG. 3). In the present embodiment, the second connection conductor 7 has a rectangular cross section (cross section along the second direction D2 and the third direction D3) orthogonal to the extension direction (first direction D1). That is, the second connection conductor 7 has a prismatic shape.

FIG. 3 is an exploded perspective view of the coil component illustrated in FIG. 1. As illustrated in FIG. 3, the coil component 1 includes a plurality of layers La, Lb, Lc, Ld, Le, Lf, and Lg. The coil component 1 is configured by, for example, laminating the layers La to Lg in order from the main surface 2c side. The coil component 1 according to the present embodiment includes a plurality of layers Lc and a plurality of layers Lg.

The layer La is configured by the element body layer 10a. The layer La constitutes the main surface 2c of the element body 2.

The layer Lb is configured by mutually combining the element body layer 10b and the coil conductor layer 12a. The element body layer 10b is provided with a defective portion (not illustrated) which has a shape corresponding to the coil conductor layer 12a and into which the coil conductor layer 12a is fitted. The element body layer 10b and the coil conductor layer 12a have a mutually complementary relationship.

The layer Lc is configured by mutually combining the element body layer 10c, the coil conductor layer 12b, and the second connection conductor layer 16a. The element body layer 10c is provided with a defective portion (not illustrated) which has a shape corresponding to the coil conductor layer 12b and the second connection conductor layer 16a and into which the coil conductor layer 12b and the second connection conductor layer 16a are fitted. The element body layer 10c and the entirety of the coil conductor layer 12b and the second connection conductor layer 16a have a mutually complementary relationship.

The layer Ld is configured by mutually combining the element body layer 10d, the coil conductor layer 12c, and the second connection conductor layer 16b. The element body layer 10d is provided with a defective portion (not illustrated) which has a shape corresponding to the coil conductor layer 12c and the second connection conductor layer 16b and into which the coil conductor layer 12c and the second connection conductor layer 16b are fitted. The element body layer 10d and the entirety of the coil conductor layer 12c and the second connection conductor layer 16b have a mutually complementary relationship.

The layer Le is configured by mutually combining the element body layer 10e, the coil conductor layer 12d, and the second connection conductor layer 16c. The element body layer 10e is provided with a defective portion (not illustrated) which has a shape corresponding to the coil conductor layer 12d and the second connection conductor layer 16c and into which the coil conductor layer 12d and the second connection conductor layer 16c are fitted. The element body layer 10e and the entirety of the coil conductor layer 12d and the second connection conductor layer 16c have a mutually complementary relationship.

The layer Lf is configured by mutually combining the element body layer 10f, the coil conductor layer 12e, and the second connection conductor layer 16d. The element body layer 10f is provided with a defective portion (not illustrated) which has a shape corresponding to the coil conductor layer 12e and the second connection conductor layer 16d and into which the coil conductor layer 12e and the second connection conductor layer 16d are fitted. The element body layer 10f and the entirety of the coil conductor layer 12e and the second connection conductor layer 16d have a mutually complementary relationship.

The layer Lg is configured by mutually combining the element body layer 10g, the first connection conductor layer 14a, and the second connection conductor layer 16e. The element body layer 10g is provided with a defective portion (not illustrated) which has a shape corresponding to the first connection conductor layer 14a and the second connection conductor layer 16e and into which the first connection conductor layer 14a and the second connection conductor layer 16e are fitted. The element body layer 10g and the entirety of the first connection conductor layer 14a and the second connection conductor layer 16e have a mutually complementary relationship. The layer Lg constitutes the main surface 2d of the element body 2.

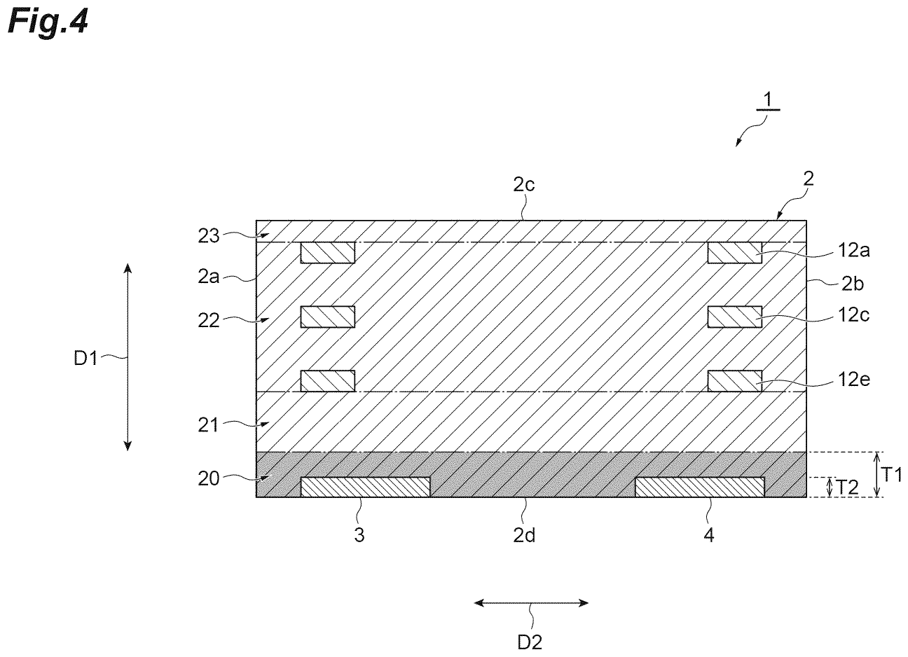

FIG. 4 is a view illustrating a cross-sectional configuration taken along the line IV-IV in FIG. 1. As illustrated in FIG. 4, the element body 2 includes a first portion 20, a second portion 21, a third portion 22, and a fourth portion 23. The first portion 20, the second portion 21, the third portion 22, and the fourth portion 23 are located in this order from the main surface 2d toward the main surface 2c.

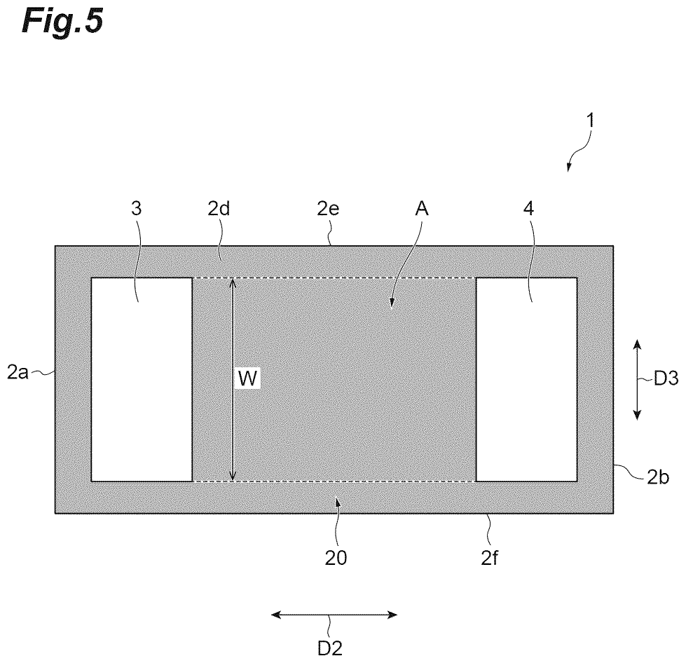

The first portion 20 includes the main surface 2d and also includes a region A (see FIG. 5) between the terminal electrode 3 and the terminal electrode 4 in the second direction D2. As illustrated in FIG. 5, the first portion 20 includes a region A having a dimension W or more of the terminal electrode 3 and the terminal electrode 4 in the third direction D3 as viewed from the first direction D1. The first portion 20 includes the entire region A between the pair of terminal electrodes 3 and 4 in the second direction D2 as viewed from the first direction D1. In the present embodiment, the first portion 20 includes the entire region A of the main surface 2d.

As illustrated in FIG. 4, the first portion 20 includes a region around each of the terminal electrode 3 and the terminal electrode 4. The first portion 20 is provided between each of the terminal electrode 3 and the terminal electrode 4 and the coil 5 (coil conductor layer 12e) in the first direction D1. A first dimension T1 of the first portion 20 in the first direction D1 is larger than a second dimension T2 of the terminal electrodes 3 and 4 in the first direction D1 (T1>T2). The first dimension T1 is preferably twice or less the second dimension T2.

The second portion 21 is a portion between the first portion 20 and the coil conductor layer 12e located closest to the main surface 2d in the first direction D1.

The third portion 22 is a portion between the coil conductor layer 12a located closest to the main surface 2c and the coil conductor layer 12e located closest to the main surface 2d in the first direction D1. Specifically, the third portion 22 is a portion between the surface of the coil conductor layer 12a on the main surface 2c side and the surface of the coil conductor layer 12e on the main surface 2d side in the first direction D1. The third portion 22 does not include a region between the coil conductor layers facing each other in the first direction D1. Specifically, the third portion 22 does not include a region between the coil conductor layer 12a and the coil conductor layer 12c facing each other in the first direction D1 and a region between the coil conductor layer 12c and the coil conductor layer 12e facing each other in the first direction D1.

The fourth portion 23 includes the main surface 2c and is a portion between the main surface 2c and the third portion 22 in the first direction D1.

In the coil component 1, an average particle diameter of the metal magnetic particles P1 (FIG. 6A) in the first portion 20 is smaller than an average particle diameter of the metal magnetic particles P2 (FIG. 6B) in any one of the second portion 21, the third portion 22, and the fourth portion 23. In the present embodiment, the average particle diameter of the metal magnetic particles P1 in the first portion 20 is smaller than the average particle diameter of the metal magnetic particles P2 in the second portion 21, the third portion 22, and the fourth portion 23. In the present embodiment, the particle diameter is defined by an equivalent circle diameter. Equivalent circle diameters of the metal magnetic particles P1 and P2 are obtained, for example, as follows.

A cross-sectional photograph of the coil component 1 is acquired. Image processing is performed on the acquired cross-sectional photograph by software. The boundary of the metal magnetic particles P1 and P2 is determined by the image processing, and the area of the metal magnetic particles P1 and P2 is obtained. From the obtained area of the metal magnetic particles P1 and P2, a particle diameter converted into an equivalent circle diameter is obtained. Here, the particle diameters of 100 or more metal magnetic particles P1 and P2 are calculated, and the particle size distribution of these metal magnetic particles P1 and P2 is obtained. The particle diameter (d50) at an integrated value of 50% in the obtained particle size distribution is taken as the “average particle diameter”. The particle shape of the metal magnetic particles P1 and P2 is not particularly limited.

As illustrated in FIG. 6A, more specifically, the metal magnetic particles P1 include normal particles P11 having an ellipsoid shape and flat particles P12 having an ellipsoid shape (disk shape) flatter in a thickness direction than the normal particles. The thickness direction is a direction defined for the sake of convenience. The normal particle P11 has a surface including a major-axis direction and a minor-axis direction orthogonal to the thickness direction. Similarly, the flat particle P12 has a surface including a major-axis direction and a minor-axis direction orthogonal to the thickness direction. For example, a particle in which a length in the major-axis direction orthogonal to the thickness direction is three times or less a length in the thickness direction is defined as the normal particle P11, and a particle in which a length in the major-axis direction orthogonal to the thickness direction exceeds three times a length in the thickness direction is defined as the flat particle P12.

The normal particle P11 and the flat particle P12 have a long diameter and a short diameter, respectively, as viewed from a direction orthogonal to the thickness direction and as viewed from the thickness direction. In a relationship between the normal particle P11 and the flat particle P12, the long diameter of the normal particle P11 is smaller than the long diameter of the flat particle P12, and the short diameter of the normal particle P11 is larger than the short diameter of the flat particle P12. A volume of the normal particle P11 is larger than a volume of the flat particle P12. The volume of the normal particle P11 may be larger than twice the volume of the flat particle P12.

For example, a scanning electron microscope (SEM) can be used for measuring the short diameter and long diameter of the normal particle P11 and the flat particle P12 and measuring the volumes. In this case, a cross-sectional photograph of the element body 2 is acquired by SEM, and the particle diameter and short diameter are measured by approximating a particle cross section to an ellipse. The volume is calculated based on an average value of particle diameters of the normal particle P11 and the flat particle P12 present in each cross section orthogonal to the first direction D1, the second direction D2, and the third direction D3 in a predetermined region of the element body 2.

A part of the normal particles P11 and the flat particles P12 arranged around the terminal electrode 3 (terminal electrode 4) is embedded in the terminal electrode 3 (terminal electrode 4). Embedded in the terminal electrode 3 (terminal electrode 4) can be said to be stuck, entered, pushed in, or bitten in. The flat particles P12 are embedded in the terminal electrode 3 (terminal electrode 4) such that the long diameter (longitudinal direction) thereof intersects an outer surface 3a (outer surface 4a) of the terminal electrode 3 (terminal electrode 4).

As described above, in the coil component 1 according to the present embodiment, the average particle diameter of the metal magnetic particles P1 in the first portion 20 of the element body 2 is smaller than the average particle diameter of the metal magnetic particles P2 in the second portion 21, the third portion 22, and the fourth portion 23. As a result, in the coil component 1, the number of the metal magnetic particles P1 existing between the pair of terminal electrodes 3 and 4 can be increased as compared with the second portion 21, the third portion 22, and the fourth portion 23. Therefore, in the coil component 1, the number of interfaces of the metal magnetic particles P1 existing between the pair of terminal electrodes 3 and 4 can be sufficiently secured, and the withstand voltage between the pair of terminal electrodes 3 and 4 can be improved. Therefore, in the coil component 1, a short circuit in the pair of terminal electrodes 3 and 4 can be suppressed.

In the coil component 1, the average particle diameter of the metal magnetic particles P2 in the second portion 21, the third portion 22, and the fourth portion 23 of the element body 2 is larger than the average particle diameter of the metal magnetic particles P1 in the first portion 20. As a result, in the coil component 1, magnetic permeability can be secured in the second portion 21, the third portion 22, and the fourth portion 23 of the element body 2. Therefore, in the coil component 1, since inductance can be secured, coil characteristics can be maintained.

In the coil component 1 according to the present embodiment, the first dimension T1 of the first portion 20 of the element body 2 in the first direction D1 is larger than the second dimension T2 of the terminal electrodes 3 and 4 in the first direction D1. In this configuration, the number of interfaces of the metal magnetic particles P1 existing between the pair of terminal electrodes 3 and 4 arranged inside the element body 2 can be sufficiently secured. Therefore, in the coil component 1, in the configuration in which the pair of terminal electrodes 3 and 4 is disposed inside the element body 2, the withstand voltage between the pair of terminal electrodes 3 and 4 can be improved.

In the coil component 1 according to the present embodiment, the first dimension T1 of the first portion 20 may be twice or less the second dimension T2 of the terminal electrodes 3 and 4. When the first dimension T1 of the first portion 20 is larger than twice the second dimension T2, the magnetic permeability of the element body 2 may decrease. In the coil component 1, by setting the first dimension T1 of the first portion 20 to be twice or less of the second dimension T2, it is possible to secure coil characteristics while suppressing a short circuit in the pair of terminal electrodes.

In the coil component 1 according to the present embodiment, the first portion 20 of the element body 2 is provided between each of the pair of terminal electrodes 3 and 4 and the coil 5 in the first direction D1. In this configuration, it is possible to suppress generation of stray capacitance between each of the pair of terminal electrodes 3 and 4 and the coil 5.

In the coil component 1 according to the present embodiment, the first portion 20 of the element body 2 includes the entire region between the pair of terminal electrodes 3 and 4 in the second direction D2 as viewed from the first direction D1. In this configuration, the withstand voltage between the pair of terminal electrodes 3 and 4 can be further improved. Therefore, in the coil component 1, a short circuit in the pair of terminal electrodes 3 and 4 can be further suppressed.

In the coil component 1 according to the present embodiment, in the first portion 20 of the element body 2, a part of the metal magnetic particles P1 located around the terminal electrodes 3 and 4 is embedded in the terminal electrodes 3 and 4. In this configuration, adhesion between the element body 2 and the terminal electrodes 3 and 4 can be secured.

In the coil component 1 according to the present embodiment, in the first portion 20 of the element body 2, the metal magnetic particles P1 include the normal particles P11 having the ellipsoid shape and the flat particles P12 having the ellipsoid shape flatter in the thickness direction than the normal particles P11. A part of the flat particles P12 is embedded in the terminal electrode 3 (terminal electrode 4) such that the long diameter of the flat particles P12 intersects the outer surface 3a (4a) of the terminal electrode 3 (terminal electrode 4). In this configuration, adhesion between the element body 2 and the terminal electrodes 3 and 4 can be secured.

Although the embodiments of the present disclosure have been described above, the present disclosure is not necessarily limited to the above-described embodiments, and various modifications can be made without departing from the gist thereof.

In the above embodiment, the mode in which the terminal electrode 3 and the terminal electrode 4 are embedded in the element body 2 has been described as an example. Specifically, in the above embodiment, the mode in which the respective surfaces of the terminal electrode 3 and the terminal electrode 4 are substantially flush with the main surface 2d has been described as an example. However, at least a part of the terminal electrodes may be embedded in the element body 2, or may be disposed on the main surface 2d. Each of the terminal electrode 3 and the terminal electrode 4 may be located to be exposed to the main surface 2d.

In the above embodiment, the mode in which each of the terminal electrode 3 and the terminal electrode 4 has a rectangular shape as viewed from the first direction D1 has been described as an example. However, the shape of each of the terminal electrode 3 and the terminal electrode 4 is not limited, and may be another shape (circular shape, elliptical shape, polygonal shape, or the like).

In the above embodiment, the mode in which the first dimension T1 of the first portion 20 in the first direction D1 is larger than the second dimension T2 of the terminal electrodes 3 and 4 in the first direction D1 (T1>T2) has been described as an example. However, the first dimension T1 may be smaller than the second dimension T2.

In the above embodiment, the mode in which the first portion 20 is provided around each of the terminal electrode 3 and the terminal electrode 4 has been described as an example. However, the first portion may not be provided around each of the terminal electrode 3 and the terminal electrode 4.

In the above embodiment, the mode in which the first portion 20 includes the entire region A of the main surface 2d has been described as an example. However, the first portion 20 may include the region A between the pair of terminal electrodes 3 and 4 in the second direction D2 as at least a part.

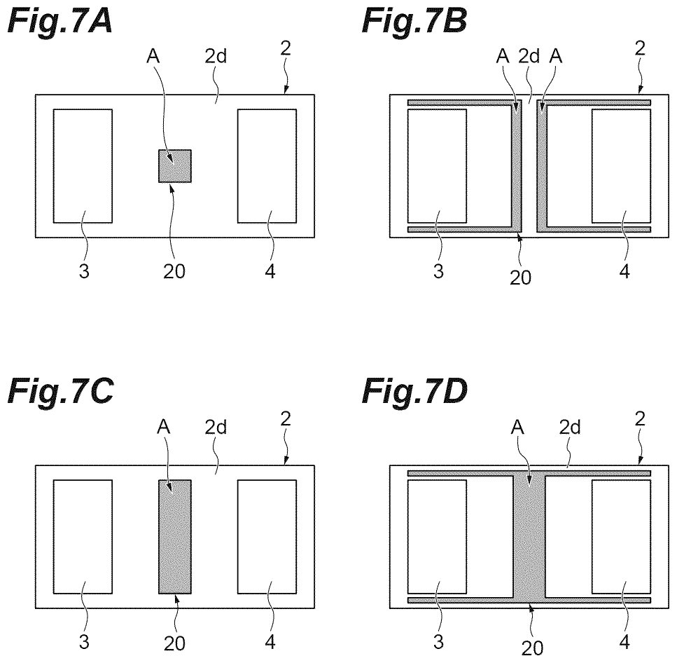

The first portion 20 may include a partial region A between the pair of terminal electrodes 3 and 4 as illustrated in FIG. 7A, or may have a U shape (channel shape) so as to include a partial region A between the pair of terminal electrodes 3 and 4 as illustrated in FIG. 7B. The first portion 20 may include a partial region A between the pair of terminal electrodes 3 and 4 as illustrated in FIG. 7C, or may have an H shape so as to include a partial region A between the pair of terminal electrodes 3 and 4 as illustrated in FIG. 7D.

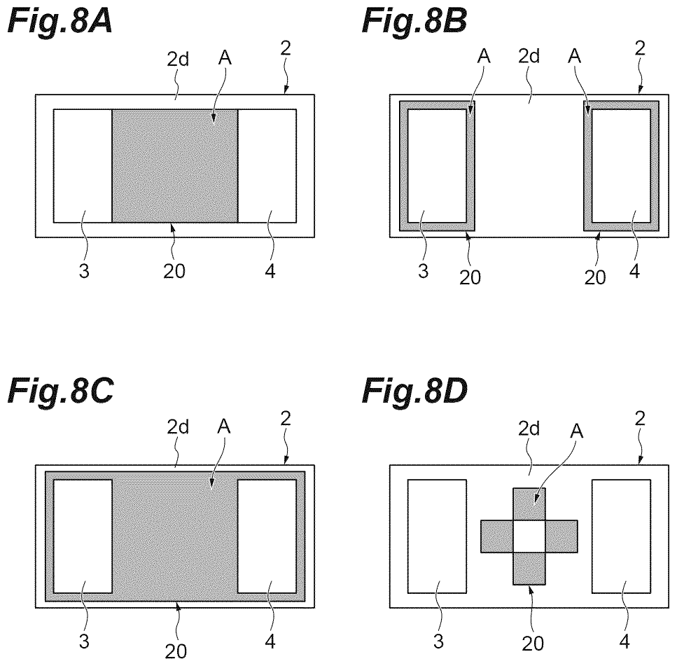

The first portion 20 may include a region A only between the pair of terminal electrodes 3 and 4 as illustrated in FIG. 8A, or may have a frame shape surrounding the periphery of the terminal electrodes 3 and 4 so as to include a partial region A between the pair of terminal electrodes 3 and 4 as illustrated in FIG. 8B. The first portion 20 may include the region A between the pair of terminal electrodes 3 and 4 and may not include the edge of the main surface 2d as illustrated in FIG. 8C, or may include a plurality of regions A between the pair of terminal electrodes 3 and 4 as illustrated in FIG. 8D.

What is claimed is:

1. A coil component comprising:
an element body formed to include a plurality of metal magnetic particles of a soft magnetic material and having a mounting surface and a main surface opposed to each other in a first direction;
a pair of terminal electrodes located to be exposed to the mounting surface and disposed to face each other in a second direction; and
a coil disposed in the element body and configured by a plurality of coil conductors, wherein
the element body includes
a first portion including the mounting surface and including a region between the pair of terminal electrodes in the second direction,
a second portion between the first portion and the coil conductor located closest to the mounting surface in the first direction,
a third portion between the coil conductor located closest to the main surface and the coil conductor located closest to the mounting surface in the first direction, the third portion not including a region between the coil conductors facing each other in the first direction, and
a fourth portion including the main surface and located between the main surface and the third portion in the first direction, and
an average particle diameter of the metal magnetic particles in the first portion is smaller than an average particle diameter of the metal magnetic particles in any of the second portion, the third portion, and the fourth portion.

2. The coil component according to claim 1, wherein at least a part of each of the pair of terminal electrodes is disposed inside the element body.

3. The coil component according to claim 1, wherein a first dimension of the first portion in the first direction is larger than a second dimension of the terminal electrode in the first direction.

4. The coil component according to claim 3, wherein the first dimension is twice or less the second dimension.

5. The coil component according to claim 1, wherein the first portion is provided between each of the pair of terminal electrodes and the coil in the first direction.

6. The coil component according to claim 1, wherein the first portion includes a region having a dimension equal to or larger than a dimension of the terminal electrode in a third direction orthogonal to the second direction as viewed from the first direction.

7. The coil component according to claim 1, wherein the first portion includes the entire region between the pair of terminal electrodes in the second direction as viewed from the first direction.

8. The coil component according to claim 1, wherein the first portion includes a region around the terminal electrode.

9. The coil component according to claim 1, wherein, in the first portion, a part of the metal magnetic particles located around the terminal electrode is embedded in the terminal electrode.

10. The coil component according to claim 9, wherein, in the first portion, the metal magnetic particles include normal particles having an ellipsoid shape and flat particles having an ellipsoid shape flatter in a thickness direction than the normal particles, and
a part of the flat particles is embedded in the terminal electrode such that a longitudinal direction of the flat particles intersects an outer surface of the terminal electrode.
